(19) United States
(12) Patent Application Publication
(10) Pub. No.: US 2016/0074950 A1
(43) Pub. Date: Mar. 17, 2016

(54) WIRE ELECTRIC DISCHARGE MACHINE

(71) Applicant: MITSUBISHI ELECTRIC CORPORATION, Tokyo (JP)

(72) Inventor: Yusuke SASAKI, Tokyo (JP)

(73) Assignee: MITSUBISHI ELECTRIC CORPORATION, Tokyo (JP)

(21) Appl. No.: 14/646,459

(22) PCT Filed: Mar. 28, 2014
(86) PCT No.: PCT/JP2014/059298

§ 371 Date: May 21, 2015

(51) Int. Cl. B23H 7/10; B23H 7/36; B23H 1/04

(52) U.S. Cl. CPC B23H 7/10; B23H 1/04; B23H 7/36

(57) ABSTRACT

A wire electric discharge machine includes a wire electrode fed downward to a workpiece to perform electric discharge machining, a direction changing unit that changes a traveling direction of the wire electrode below the workpiece, a collection roller that collects the wire electrode, the traveling direction of which is changed, an extendable conveying pipe provided between the direction changing unit and the collection roller, the wire electrode being inserted through the inside of the conveying pipe, a supply unit that supplies the machining fluid into the conveying pipe, a supply-amount-information detecting unit that detects information concerning a supply amount of the machining fluid supplied to the conveying pipe, and a control unit that controls supply capacity for feeding the machining fluid to the conveying pipe from the supply unit on the basis of the information from the supply-amount-information detecting unit.

### FIELD

The present invention relates to a wire electric discharge machine including a wire collecting device.

### BACKGROUND

A wire electric discharge machine machines a workpiece into any shape using a wire electrode positioned by an upper wire guide and a lower wire guide. In general, the wire electric discharge machine includes a wire automatic connection device that pierces the wire electrode, which performs electric discharge machining, through a machining start hole of the workpiece and automatically connects the wire electrode to a collection roller that collects the wire electrode. The wire electric discharge machine applies, while collecting the wire electrode, a pulse voltage between the wire electrode and the workpiece to thereby relatively move the workpiece and the wire electrode to perform the electric discharge machining.

As the wire automatic connection device provided in the wire electric discharge machine, for example, Patent Literature 1 discloses a configuration for inserting a wire electrode into a pipe extending toward a collection roller and feeding machining fluid into the pipe toward the collection roller to convey the wire electrode to the collection roller.

### CITATION LIST

### Patent Literature

Patent Literature 1: WO 99/032252

### SUMMARY

### Technical Problem

In the wire automatic connection device disclosed in Patent Literature 1, the length of the pipe fluctuates according to the movement of the wire electrode. Because the length of the pipe fluctuates, a pressure loss in a channel of the machining fluid fluctuates. Therefore, there is a problem in that, when the machining fluid is supplied into the pipe with fixed supply capacity, excess or shortage of a flow rate of the machining fluid easily occurs because the length of the pipe fluctuates. For example, when the flow rate of the machining fluid is too high, the machining fluid adheres to the collection roller and the wire electrode easily entwines the collection roller. When the flow rate of the machining fluid is too low, a conveying force for the wire electrode decreases, and it is likely that the wire electrode does not reach the collection roller and cannot be connected.

The present invention has been devised in view of the above and it is an object of the present invention to obtain a wire electric discharge machine that can stably connect a wire electrode even if the length of a pipe for conveying the wire electrode fluctuates.

### Solution to Problem

In order to solve the aforementioned problems, a wire electric discharge machine according to one aspect of the present invention is constructed in such a manner as to include: a wire electrode fed downward to a workpiece to perform electric discharge machining; a direction changing unit that changes a traveling direction of the wire electrode below the workpiece; a collection roller that collects the wire electrode, the traveling direction of which has been changed; an extendable conveying pipe, which is provided between the direction changing unit and the collection roller, and inside of which the wire electrode is inserted through; a supply unit that supplies the machining fluid into the conveying pipe to cause the machining fluid to flow in the conveying pipe from the direction changing unit side toward the collection roller side; a supply-amount-information detecting unit that detects information concerning a supply amount of the machining fluid supplied to the conveying pipe; and a control unit that controls supply capacity for feeding the machining fluid to the conveying pipe from the supply unit on the basis of the information from the supply-amount-information detecting unit.

### Advantageous Effects of Invention

The wire electric discharge machine according to the present invention has an effect that it is possible to stably connect the wire electrode even if the length of the pipe for conveying the wire electrode fluctuates.

### BRIEF DESCRIPTION OF DRAWINGS

FIG. 1 is a diagram illustrating the schematic configuration of a wire electric discharge machine according to a first embodiment.

FIG. 2 is a diagram illustrating an example of a state in which an inner pipe is inserted into an outer pipe.

FIG. 3 is a diagram illustrating a state in which the inner pipe is inserted into the outer pipe more deeply than in the state shown in FIG. 2.

FIG. 4 is a diagram illustrating, as a first modification, an example in which a flow meter is provided as a supply-amount-information detecting unit.

FIG. 5 is a diagram illustrating, as a second modification, an example in which a pressure gauge is provided as the supply-amount-information detecting unit.

FIG. 6 is a diagram illustrating, as a third modification, an example in which a plurality of supply pumps are included as a supply unit.

FIG. 7 is a diagram illustrating, as a fourth modification, an example in which an electromagnetic valve is provided to control the supply capacity for feeding machining fluid.

FIG. 8 is a diagram illustrating, as a fifth modification, an example in which an electromagnetic valve is provided to control the supply capacity for feeding the machining fluid.

### DESCRIPTION OF EMBODIMENTS

A wire electric discharge machine according to an embodiment of the present invention is explained in detail below with reference to the drawings. Note that the present invention is not limited by the embodiment.

### First Embodiment

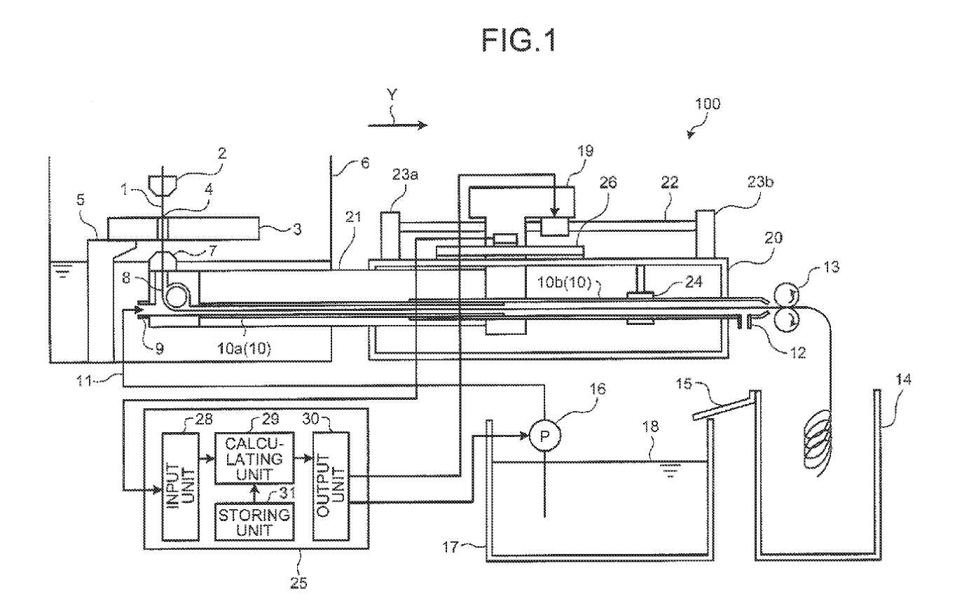

FIG. 1 is a diagram illustrating the schematic configuration of a wire electric discharge machine according to a first embodiment. A wire electric discharge machine 100 machines a workpiece 3 using a wire electrode 1 pierced through a machining start hole 4 formed in the workpiece 3. The wire electrode 1 is positioned by an upper wire guide 2 provided above the workpiece 3 and a lower wire guide 7 provided below the workpiece 3. A mounting surface plate 5, on which the workpiece 3 is set, and a work tank 6, in which machining fluid is stored, are provided around the upper wire guide 2 and the lower wire guide 7.

The wire electrode 1 travels downward while being positioned by the upper wire guide 2 and the lower wire guide 7. The traveling direction of the wire electrode 1 is changed to the horizontal direction by a lower roller (a direction changing unit) 8 provided below the lower wire guide 7. The wire electrode 1 traveling in the horizontal direction is wound on a collection roller 13 and collected in a wire-electrode collection box 14.

A conveying pipe 10 extending in the horizontal direction is provided between the lower roller 8 and the collection roller 13. The wire electrode 1 is inserted through the conveying pipe 10. The conveying pipe 10 includes an inner pipe 10a and an outer pipe 10b. The outer diameter of the inner pipe 10a is smaller than the inner diameter of the outer pipe 10b. The inner pipe 10a is inserted into the inner side of the outer pipe 10b. The length of the entire conveying pipe 10 can be increased or decreased by changing an insertion amount of the inner pipe 10a.

Machining fluid 18 is fed to the inside of the conveying pipe 10 from the lower roller 8 side to the collection roller 13 side. Therefore, a machining-fluid supply port 9 for causing the machining fluid 18 to flow into the inside of the conveying pipe 10 and a discharge port 12 for causing the machining fluid 18 to flow out from the inside of the conveying pipe 10 are provided.

The machining fluid 18 fed into the conveying pipe 10 is supplied from the machining fluid 18 stored in a tank 17. The machining fluid 18 discharged from the discharge port 12 is returned to the tank 17 via a gutter 15. The wire electric discharge machine 100 includes a supply pump (a supply unit) 16 for supplying the machining fluid 18 into the conveying pipe 10. The supply pump 16 is capable of changing a discharge amount (an output). The primary side of the supply pump 16 is connected to the tank 17. A connection pipe 11 that connects the supply pump 16 and the machining-fluid supply port 9 is provided on the secondary side of the supply pump 16.

A driving mechanism for moving the upper wire guide 2 and the lower wire guide 7 in a direction indicated by an arrow Y (a direction in which the conveying pipe 10 extends) to machine the workpiece 3 into a desired shape is explained. The driving mechanism includes a slider 19, a saddle 20, and a driving device 22.

The slider 19 is coupled to the lower wire guide 7 via the lower arm 21. The driving device 22 moves the slider 19 in the direction indicated by the arrow Y. According to the movement of the slider 19 in the direction indicated by the arrow Y, the lower arm 21, the lower wire guide 7, the upper wire guide 2, and the inner pipe 10a integrally move. The driving device 22 is fixed to a saddle 20 via clamps 23a and 23b. The outer pipe 10b is fixed to the saddle 20 by a metal fitting 24. In the driving mechanism, a linear scale 26 that detects the position of the slider 19 is provided as a supply-amount-information detecting unit that detects information concerning a supply amount of the machining fluid 18 (supply amount information).

With the driving mechanism, the slider 19 is moved by the driving device 22, whereby the upper wire guide 2 and the lower wire guide 7, that is, the wire electrode 1 is moved and the workpiece 3 is machined. According to the movement of the slider 19, the inner pipe 10a also moves.

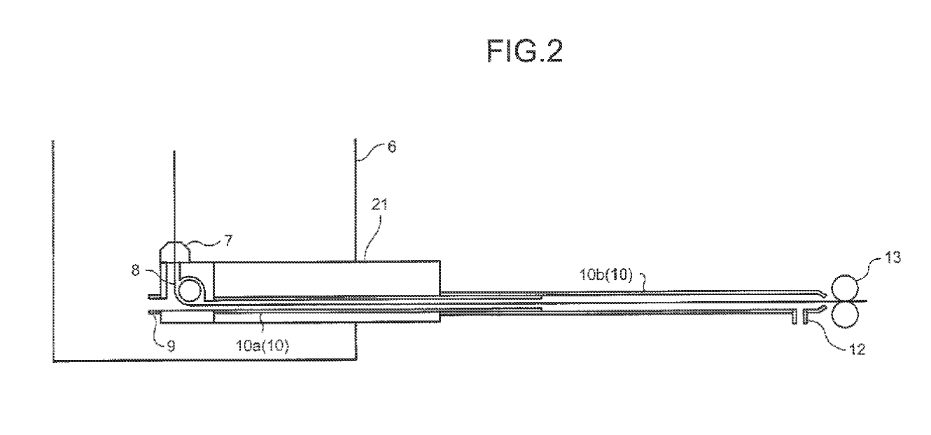

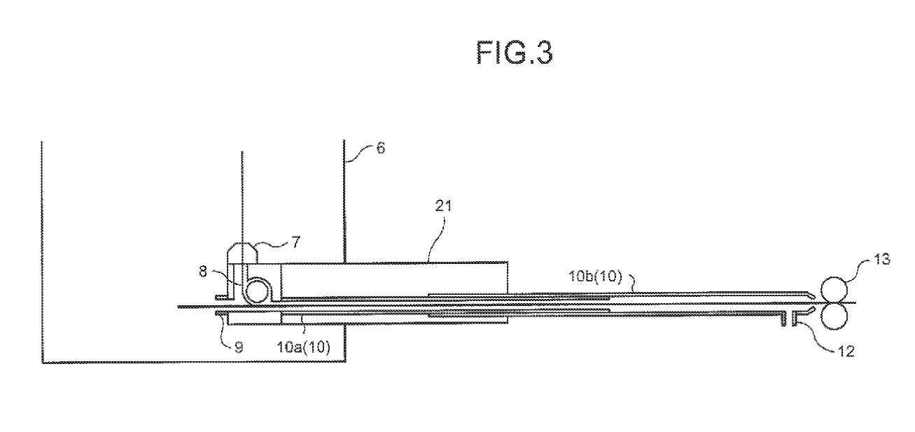

FIG. 2 is a diagram showing an example of a state in which the inner pipe 10a is inserted into the outer pipe 10b. FIG. 3 is a diagram showing a state in which the inner pipe 10a is inserted into the outer pipe 10b more deeply than in the state shown in FIG. 2. According to the movement of the inner pipe 10a, the insertion amount into the outer pipe 10b changes and the length of the entire conveying pipe 10 changes. Specifically, the insertion amount of the inner pipe 10a is larger and the length of the entire conveying pipe 10 is smaller in the example shown in FIG. 3 than in the example shown in FIG. 2.

A control device 25 that performs control of the driving mechanism and the like is explained. The control device 25 includes an input unit 28, a calculating unit 29, an output unit 30, and a storing unit 31. Position information from the linear scale 26 is input to the input unit 28. The calculating unit 29 calculates a discharge amount (an output) of the supply pump 16 on the basis of information stored in the storing unit 31 and the position information input to the input unit 28. The output unit 30 outputs control information in order to drive the supply pump 16 with the discharge amount calculated by the calculating unit 29. The control device 25 controls the driving device 22 to move the wire electrode 1 on the basis of a machining program stored in the storing unit 31.

A connecting operation for the wire electrode 1 in the wire electric discharge machine 100 is explained. The wire electrode 1 passes through the upper wire guide 2, pierces through the machining start hole 4 of the workpiece 3, and passes through the lower wire guide 7. The traveling direction of the wire electrode 1 is changed from the vertical direction to the horizontal direction by the lower roller 8 below the lower wire guide 7. The wire electrode 1 is inserted into the conveying pipe 10.

The machining fluid 18 is fed into the conveying pipe 10 from the lower roller 8 side toward the collection roller 13 side, whereby the wire electrode 1 inserted into the conveying pipe 10 is conveyed to the collection roller 13. The wire electrode 1 is rolled up by the collection roller 13 and collected in the wire-electrode collection box 14.

To convey the wire electrode 1 in the conveyor pipe 10, it is necessary to feed a sufficient amount of the machining fluid 18 into the conveying pipe 10. For example, when a flow rate of the machining fluid 18 is too high, the machining fluid 18 cannot be fully discharged in the discharge port 12 and adheres to the collection roller 13, and the wire electrode 1 easily entwines the collection roller 13. When the flow rate of the machining fluid 18 is too low, a conveying force for the wire electrode 1 decreases, and it is likely that the wire electrode 1 does not reach the collection roller 13 and cannot be connected.

As shown in FIGS. 2 and 3, because the length of the conveying pipe 10 fluctuates, a pressure loss due to passage of fluid through the inside of the conveying pipe 10 also fluctuates. Therefore, in the wire electric discharge machine 100 according to this embodiment, the discharge amount (the output) of the machining fluid 18 by the supply pump 16 is changed according to the length of the conveying pipe 10.

In the storing unit 31 of the control device 25, a relational expression between the length of the conveying pipe 10 and an output of the supply pump 16 for setting the machining fluid 18 flowing through the conveying pipe 10 to an appropriate flow rate is stored. The calculating unit 29 calculates, from length information of the conveying pipe 10 input from the input unit 28 and the relational expression stored in the storing unit 31, an output of the supply pump 16 for setting a flow rate suitable for the conveyance of the wire electrode 1. Information concerning the calculated output is output from the output unit 30 to the supply pump 16. Note that, when the driving device 22 is a ball screw, the length information can be acquired from an encoder of a motor that drives the ball screw.

Because the length of the conveying pipe 10 is larger in the example shown in FIG. 2 than in the example shown in FIG. 3, the pressure loss is larger. Therefore, the discharge amount (the output) of the supply pump 16 is set larger in the example shown in FIG. 2 than in the example shown in FIG. 3. That is, in this embodiment, the supply capacity for feeding the machining fluid 18 to the conveying pipe 10 is increased by setting the output of the supply pump 16 larger as the length of the conveying pipe 10 is larger.

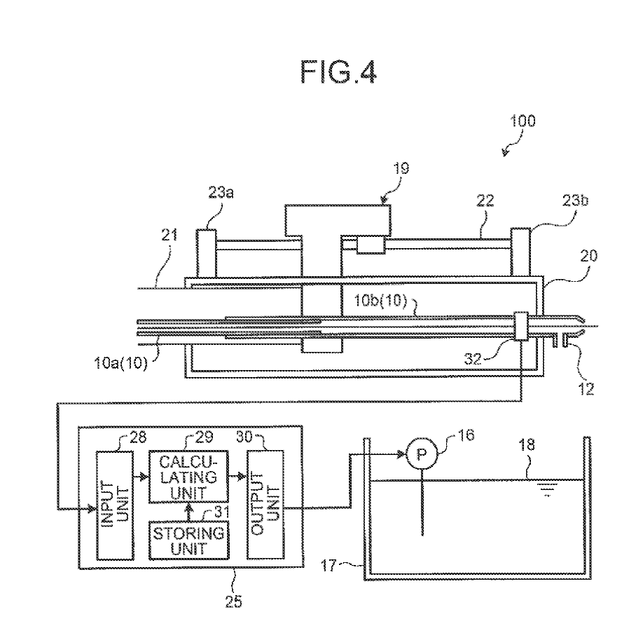

FIG. 4 is a diagram illustrating, as a first modification, an example in which a flow meter 32 is provided for the supply-amount-information detecting unit. In the first modification, as the supply-amount-information detecting unit, the flow meter 32 is provided instead of the linear scale 26 (see FIG. 1). The flow meter 32 measures a flow rate of the machining fluid 18 flowing through the inside of the conveying pipe 10. The flow meter 32 outputs information concerning the measured flow rate to the input unit 28 of the control device 25.

In the storing unit 31 of the control device 25, a relational expression for calculating a change amount of the output of the supply pump 16 from a difference between information concerning the flow rate of the machining fluid 18 suitable for conveying the wire electrode 1 in the conveying pipe 10 and the flow rate information given from the flow meter 32 is stored. The calculating unit 29 calculates, on the basis of the calculation formula stored in the storing unit 31, the change amount of the output of the supply pump 16 to bring the flow rate information given from the flow meter 32 close to the flow rate suitable for the conveyance of the wire electrode 1. Information concerning the calculated change amount is output from the output unit 30 to the supply pump 16. In this way, the supply capacity for feeding the machining fluid 18 is controlled to set the flow rate of the machining fluid 18 flowing through the conveying pipe 10 to a predetermined flow rate.

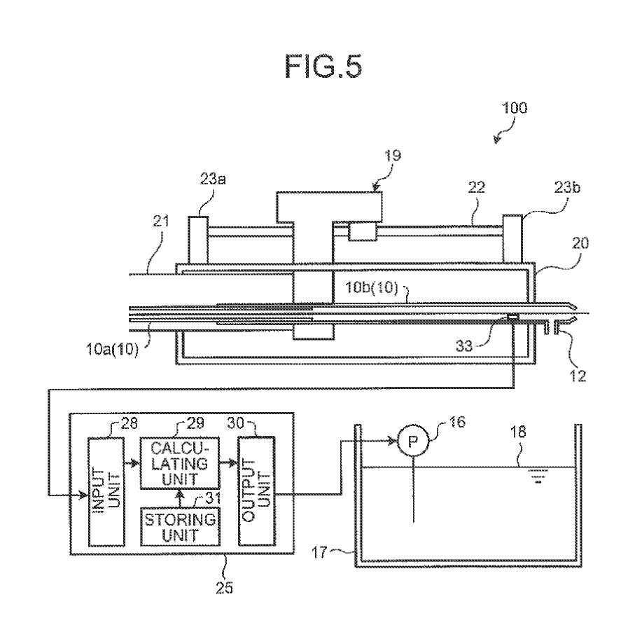

FIG. 5 is a diagram illustrating, as a second modification, an example in which a pressure gauge 33 is provided for the supply-amount-information detecting unit. In the second modification, as the supply-amount-information detecting unit, the pressure gauge 33 is provided instead of the linear scale 26 (see FIG. 1). The pressure gauge 33 measures the pressure of the machining fluid 18 flowing through the inside of the conveying pipe 10. The pressure gauge 33 outputs information concerning the measured pressure to the input unit 28 of the control device 25.

In the storing unit 31 of the control device 25, information concerning the pressure of the machining fluid 18 fed at the flow rate suitable for conveying the wire electrode 1 in the conveying pipe 10 is stored. Further, in the storing unit 31, a relational expression for calculating the change amount of the output of the supply pump 16 from a difference between the pressure information given from the pressure gauge 33 and the information concerning the pressure suitable for the conveyance of the wire electrode 1 is stored. The calculating unit 29 calculates, on the basis of the calculation formula stored in the storing unit 31, the change amount of the output of the supply pump 16 to bring the pressure information given from the pressure gauge 33 close to the pressure suitable for the conveyance of the wire electrode 1. Information concerning the calculated change amount is output from the output unit 30 to the supply pump 16. In this way, the supply capacity for feeding the machining fluid 18 is controlled to set the pressure of the machining fluid 18 flowing in the conveying pipe 10 to predetermined pressure.

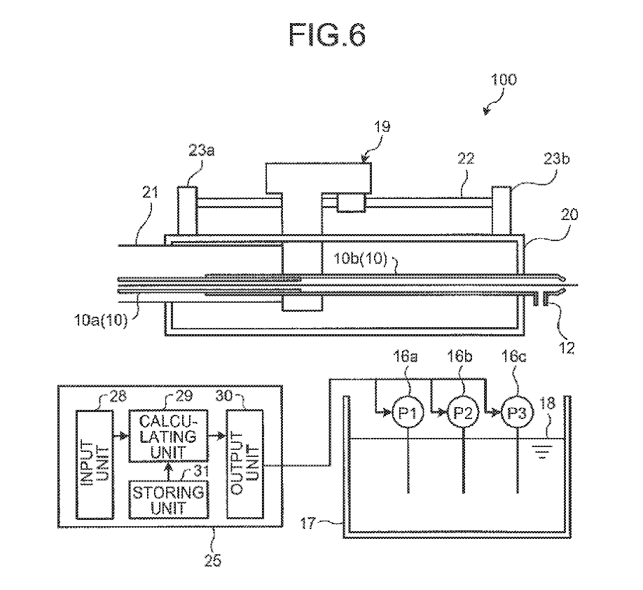

FIG. 6 is a diagram illustrating, as a third modification, an example in which a plurality of supply pumps 16a to 16c are included as a supply unit. In the third modification, the wire electric discharge machine 100 includes the supply pumps 16a to 16c as a supply unit that supplies the machining fluid 18 into the conveying pipe 10. The supply pumps 16a to 16c are connected in parallel. Note that the number of the supply pumps connected in parallel is not limited to three and can be any number.

The control device 25 changes the number of supply pumps to be driven among the supply pumps 16a to 16c to control the supply capacity for feeding the machining fluid 18 to the conveying pipe 10. In the storing unit 31 of the control device 25, a relational expression between outputs of the supply pumps 16a to 16c and the supply amount information for supplying the machining fluid 18 at the flow rate suitable for conveying the wire electrode 1 in the conveying pipe 10 is stored. The calculating unit 29 calculates, from the relational expression stored in the storing unit 31, the number of supply pumps 16a to 16c that should be driven to set the flow rate to the flow rate suitable for the conveyance of the wire electrode 1. The output unit 30 outputs a command to the supply pump 16 to drive the calculated number of the supply pumps 16a to 16c.

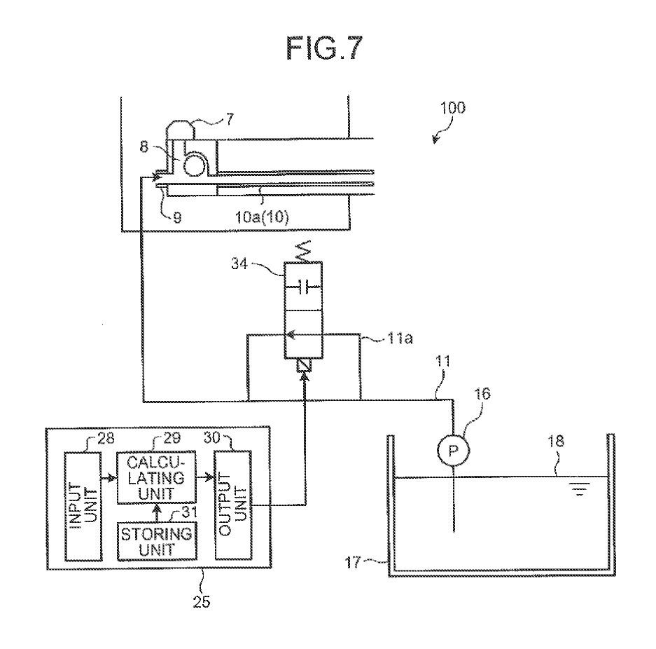

FIG. 7 is a diagram illustrating, as a fourth modification, an example in which an electromagnetic valve 34 is provided to control the supply capacity for feeding the machining fluid 18. In the fourth modification, a branch pipe 11a is divided from the connection pipe 11 that connects the supply pump 16 and the machining-fluid supply port 9. The electromagnetic valve 34 is provided halfway in the branch pipe 11a. The branch pipe 11a is connected to connection pipe 11 again further on the downstream side than the electromagnetic valve 34.

The control device 25 changes the opening degree of the electromagnetic valve 34 to vary a pressure loss due to piping from the supply pump 16 to the machining-fluid supply port 9 and control the supply capacity for feeding the machining fluid 18 to the conveying pipe 10.

In the storing unit 31 of the control device 25, a relational expression between the opening degree of the electromagnetic valve 34 and the supply amount information for supplying the machining fluid 18 at the flow rate suitable for conveying the wire electrode 1 in the conveying pipe 10 is stored. The calculating unit 29 calculates, from the relational expression stored in the storing unit 31, the opening degree of the electromagnetic valve 34 for setting the flow rate to the flow rate suitable for the conveyance of the wire electrode 1. The output unit 30 outputs a command to the electromagnetic valve 34 to set the opening degree of the electromagnetic valve 34 to the calculated opening.

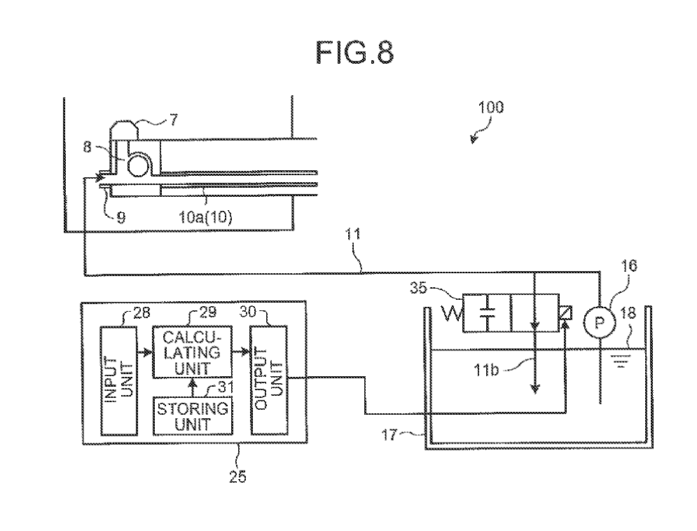

FIG. 8 is a diagram illustrating, as a fifth modification, an example in which an electromagnetic valve 35 is provided to control the supply capacity for feeding the machining fluid 18. In the fifth modification, a branch pipe 11b is divided from the connection pipe 11 that connects the supply pump 16 and the machining-fluid supply port 9. The electromagnetic valve 35 is provided halfway in the branch pipe 11b. The branch pipe 11b is opened to the tank 17 further on the downstream side than the electromagnetic valve 35.

The control device 25 changes the opening degree of the electromagnetic valve 35 to return a part of the machining fluid 18, which flows through the connection pipe 11, to the tank 17 to control the supply capacity for feeding the machining fluid 18 to the conveying pipe 10.

In the storing unit 31 of the control device 25, a relational expression between the opening degree of the electromagnetic valve 35 and the supply amount information for supplying the machining fluid 18 at the flow rate suitable for conveying the wire electrode 1 in the conveying pipe 10 is stored. The calculating unit 29 calculates, from the relational expression stored in the storing unit 31, the opening degree of the electromagnetic valve 35 for setting the flow rate to the flow rate suitable for the conveyance of the wire electrode 1. The output unit 30 outputs a command to the electromagnetic value 35 to set the opening degree of the electromagnetic valve 35 to the calculated opening.

With the wire electric discharge machine configured as explained above, the supply capacity for feeding the machining fluid 18 from the supply pump 16 is controlled on the basis of the supply amount information obtained from the linear scale 26 and the like. Therefore, even if the length of the conveying pipe 10 changes, it is possible to feed the machining fluid 18 to the conveying pipe 10 at an appropriate flow rate. Consequently, it is possible to stably connect the wire electrode 1 irrespective of a change in the length of the conveying pipe 10.

Note that the various configurations illustrated in this embodiment can be combined. For example, the linear scale 26 and the flow meter 32 illustrated as the supply-amount-information detecting unit provided to obtain supply amount information can be used in combination. The configuration in which a plurality of the supply pumps are provided and the configuration in which the electromagnetic valves 34 and 35 are provided, that are illustrated to change the supply capacity for feeding the machining fluid 18 from the supply pump 16, can be combined. The control based on the length of the conveying pipe 10 and the control based on an actual flow rate can be combined.

### INDUSTRIAL APPLICABILITY

As explained above, the wire electric discharge machine according to the present invention is useful for a wire electric discharge machine that feeds machining fluid into a pipe and connects a wire electrode.

### REFERENCE SIGNS LIST

1 Wire electrode

2 Upper wire guide

3 Workpiece

4 Machining start hole

5 Mounting surface plate

6 Work tank

7 Lower wire guide

8 Lower roller (direction changing unit)

9 Machining-fluid supply port

10 Conveying pipe

10a Inner pipe

10b Outer pipe

11 Connection pipe

11a Branch pipe

11b Branch pipe

12 Discharge port

13 Collection roller

14 Wire-electrode collection box

16, 16a, 16b, 16c Supply pumps (supply units)

17 Tank

18 Machining fluid

19 Slider

20 Saddle

21 Lower arm

22 Driving device

23a, 23b Clamps

24 Metal fitting

25 Control device

26 Linear scale (supply-amount-information detecting unit)

28 Input unit

29 Calculating unit

30 Output unit

31 Storing unit

32 Flow meter (supply-amount-information detecting unit)

33 Pressure gauge (supply-amount-information detecting unit)

34, 35 Electromagnetic valves

100 Wire electric discharge machine

1. A wire electric discharge machine comprising:
a wire electrode fed downward to a workpiece to perform electric discharge machining;
a direction changing unit that changes a traveling direction of the wire electrode below the workpiece;
a collection roller that collects the wire electrode, the traveling direction of which has been changed;
an extendable conveying pipe, which is provided between the direction changing unit and the collection roller, and inside of which the wire electrode is inserted through;
a supply unit that supplies the machining fluid into the conveying pipe to cause the machining fluid to flow in the conveying pipe from the direction changing unit side toward the collection roller side;
a supply-amount-information detecting unit that detects information concerning a supply amount of the machining fluid supplied to the conveying pipe; and
a control unit that controls supply capacity for feeding the machining fluid to the conveying pipe from the supply unit on the basis of the information from the supply-amount-information detecting unit.

2. The wire electric discharge machine according to claim 1, wherein
the information detected by the supply-amount-information detecting unit is length information of the conveying pipe, and
the control unit sets the supply capacity larger as the length of the conveying pipe is larger.

3. The wire electric discharge machine according to claim 1, wherein
the information detected by the supply-amount-information detecting unit is flow rate information of the machining fluid flowing in the conveying pipe, and
the control unit controls the supply capacity to set a flow rate of the machining fluid flowing in the conveying pipe to a predetermined flow rate.

4. The wire electric discharge machine according to claim 1, wherein
the information detected by the supply-amount-information detecting unit is pressure information in the conveying pipe, and
the control unit controls the supply capacity to set pressure in the conveying pipe to predetermined pressure.

5. The wire electric discharge machine according to claim 1, wherein the control unit changes an output of the supply unit and controls the supply capacity.

6. The wire electric discharge machine according to claim 1, wherein
a plurality of the supply units are provided, and
the control unit changes a number of the supply units to be driven and controls the supply capacity.

7. The wire electric discharge machine according to claim 1, further comprising:
a connection pipe that connects the supply unit and the conveying pipe;
a branch pipe divided from the connection pipe; and
an electromagnetic valve provided halfway in the branch pipe, wherein
the control unit changes opening degree of the electromagnetic valve and controls the supply capacity.

8. The wire electric discharge machine according to claim 7, wherein the branch pipe is connected to the connection pipe again further on a downstream side than the electromagnetic valve.

9. The wire electric discharge machine according to claim 7, wherein an end on the downstream side of the branch pipe is opened.
